(19) United States
(12) Patent Application Publication
(10) Pub. No.: US 2019/0152071 A1
(43) Pub. Date: May 23, 2019

(54) HANDLING SYSTEM

(71) Applicant: EISELE PNEUMATICS GMBH & CO. KG, Waiblingen (DE)

(72) Inventor: Viktor DEISTER, Backnang (DE)

(21) Appl. No.: 16/313,193

(22) PCT Filed: Jun. 19, 2017
(86) PCT No.: PCT/EP2017/000706

§ 371 Date: Dec. 26, 2018

(30) Foreign Application Priority Data
Jun. 28, 2016 (DE) 10 2016 008 112.0

(51) Int. Cl. B25J 19/00

(52) U.S. Cl. CPC B25J 19/0025; B25J 9/04

(57) ABSTRACT

1. Handling system. 2. A handling system with a handling arm (4) which preferably consists of several arm parts (6, 8) which are movable by means of at least one drive and which are connected to each other via joints (12, 18), and with a supply device (20) having individual supply sections which serve to deliver electrical and/or fluidic energy to consumers, such as the respective drive, and which at least in part constitute a component of the handling arm (4) with its arm parts (6, 8), characterized in that the individual supply sections are combined to form a common main section (20) which at each end has a respective connection coupling part (26, 28) which, with a casing (22), surrounds and protects the supply sections and which, designed as an exchangeable unit, is mounted detachably on the handling arm (4) via receivers (40) located on the two coupling parts (26, 28) and is accessible from the outside.

The invention relates to a handling system, having a handling arm, which preferably consists of several arm parts moved by means of at least one drive, which arm parts are interconnected via joints, and having a supply device, which has individual supply strands, which supply electrical and/or fluidic energy to loads, such as the relevant drive, and which are at least partially part of the handling arm and its arm parts.

Handling systems of this kind belong to the prior art. In particular, such systems are used in industrial manufacturing as a manipulator component of industrial robots. Depending on the design of the operating system based on electric, pneumatic or hydraulic drives, having dedicated control systems and possibly existing sensors, the supply device has a corresponding number of supply strands in the form of electrical lines and hose lines. In the known handling systems, these are routed inside the arm parts starting from the device base supporting the handling arm to the relevant load. This means that if it is necessary to exchange any supply lines, such as is required if the handling function of the system is altered or to remedy a line fault, the supply device must be removed from the arm parts, which is laborious and time consuming and can result in high failure costs during manufacturing operation.

In view of this issue, the invention addresses the problem of providing a handling system that can be operated inexpensively and efficiently.

According to the invention, this object is achieved by a handling system having the features of claim 1 in its entirety.

According to the characterizing part of claim 1, the invention is characterized in that the individual supply strands are combined to form a common main strand, which has a port-coupling part, which surrounds the supply strands with a protective sheath and which, designed as an exchangeable unit, is mounted on the handling arm using retainers located on the two coupling parts in a detachable manner and accessible from the outside. Necessary changes of the utility device, such as replacement of supply strands to remedy defects or because of changing handling tasks of the system, can be accomplished quickly and easily in the invention by removing and replacing the main line containing the supply strands. As a result, labor costs and costs for maintenance are minimized, just like the costs caused by downtime.

The port-coupling parts located at the ends of the sheath can be formed by the coupling elements of a multi-media multiple coupling according to the prior art, as disclosed for instance in the document DE 10 2012 001 529 A1. For coupling parts of this type, the retainer provided for detachable attachment on the relevant handling arm can be connected to a main body of the relevant coupling part.

The arrangement may advantageously be such that the first free end or first coupling part of the main strand is arranged on the first arm part and its other free end or second coupling part is arranged on the last arm part of the handling arm, wherein the first coupling part is used to supply the energy and the second coupling part is used for the output of the supplied energy. The supplied energy may be electrical energy in the form of drive energy and/or control and/or sensor signals or pneumatic and/or hydraulic pressure energy.

Advantageously, the first arm part can be pivotably arranged on a base, wherein the last arm part of the handling arm has a handling or processing unit to be supplied with energy.

In particularly advantageous embodiments, the sheath of the main strand, just like the individual supply strands, is flexible and follows every intended movement of the arm parts of the handling arm, such that it ensures the supply of energy and infeed in particular in the extended state of the handling arm and running in parallel to the latter. Advantageously, for this purpose the sheath may be formed by a corrugated plastic pipe.

With particular advantage, the arrangement can be made such that the main strand is arranged freely movable on the outside of the arm parts except for the two coupling parts and their retainers, which outside extends along a plane of movement thereof.

In the case of completely folded arm parts, the main strand undergoes a maximum deflection at the relevant joint, in which the strand parts of the main strand, including the relevant coupling part, adjacent to the deflection, can be brought in contact with each other without any kinks.

In advantageous embodiments, the relevant retainer has a standardized connection device for a coupling part of the main strand, which connection device can be connected to a dedicated holding device on one of the arm parts in a detachable manner, the arrangement being such that all exchangeable main strands, even those having a different configuration, can be attached to the relevant arm part using the standardized connection device.

Subject matter of the invention is also a supply device having individual, flexibly formed supply strands for the supply of electrical and/or fluidic energy, wherein the supply device is provided in particular for a movable arm of a handling system according to one of claims 1 to 7 and has the features of claim 8.

Further features of the supply system are specified in the subsequent patent claims 9 and 10.

The invention is explained in detail below, with reference to an embodiment shown in the drawings.

In the drawings:

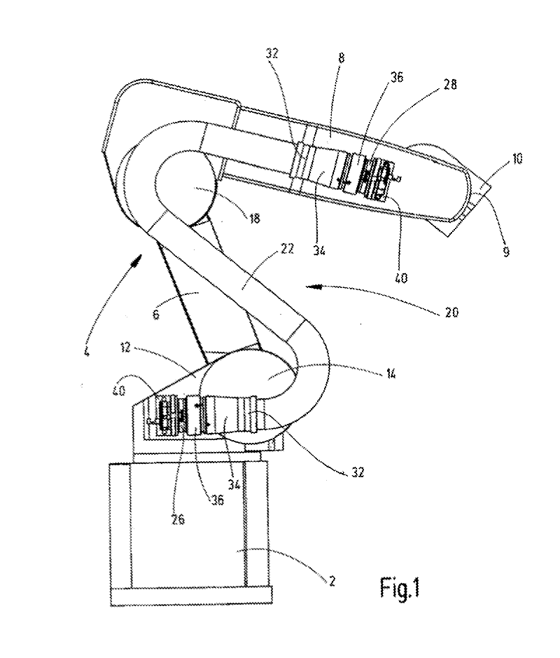

FIG. 1 shows a schematically simplified side view of an exemplary embodiment of the handling system according to the invention, and

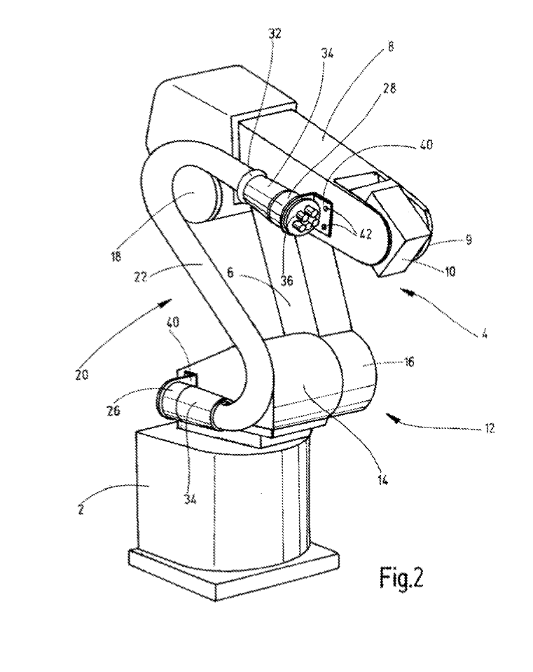

FIG. 2 shows a schematically simplified oblique perspective view of the exemplary embodiment, as seen on the end of the last arm part of the handling arm.

In the drawings, a device base of the exemplary embodiment, which base is anchored to a floor surface for stationary usage of the system, is designated by 2. On the base 2, a handling arm designated as a whole by 4 is rotatably mounted such that it can rotate 360° about a vertical axis in the manner customary for such systems. In the example shown, the handling arm 4 has two arm parts 6 and 8 in the form of beams having a rectangular cross-section, of which the upper, last arm part 8 has an effector 10 at the free end 9 indicated only schematically. This effector can be moved in the manner usual for such manipulators by means of dedicated drive and control devices, wherein in the example shown, a pivoting mobility about a horizontal axis perpendicular to the longitudinal axis of the arm member 8 is provided.

The first, lower arm part 6 is connected to the base 2 via a joint 12, which has a first joint part 14, which is rotatable about the vertical axis at the base 2, and a second joint part 16, which is pivotally mounted about a horizontal axis on the first joint part 14. The upper end of the first arm part 6 is connected to the inner end of the last arm part 8 via a second joint 18, which provides a pivoting option for the upper, last arm part 8 about a horizontal axis, which runs vertically to the longitudinal axes of both arm parts 6 and 8. The two horizontal pivot axes of the joints 12 and 18 provide for a vertical plane of motion for the movements of the arm parts 6 and 8.

The supply device in the invention, which has the individual supply strands for the actuation of the effector 10, is formed by a separate structural unit, which is designed as a exchangeable unit and is detachably attached to the outside of the handling arm 4. For this purpose, the supply device has a main strand 20, in which all supply strands combined are routed within a flexible sheath 22, the course of which follows the movements of the arm parts 6, 8 of the handling arm 4 during operation of the handling system. A corrugated pipe made of metal or plastic is provided as a flexible sheath 22 in the invention, which pipe permits a deflection of the strand route at the joints 12 and 18 without any kinks, even in the completely folded state of the arm parts 6, 8 and at maximum deflection, in which the strand parts of the sheath 22 adjacent to the deflection points are in contact with one another.

At each end of the main strand 20, a coupling part is provided, of which a first coupling part designated by 26 is provided for the supply of energy and a second coupling part, designated by 28, is provided for the delivery of the injected energy. The first coupling part 26 is mounted on the joint 12, and the second coupling part 28 is mounted in the vicinity of the outer end 9 of the last arm part 8. The coupling parts 26, 28 are each a part of a pair of the coupling elements of a multiple multi-media coupling of the known type, which permits the simultaneous coupling of electrical connections and lines containing pressurized fluids. For this purpose, the present coupling parts 26 and 28 can be formed by one of the coupling elements designated by 2 and 4 in FIG. 3 in the cited document DE 10 2012 001 529 A1, their fluidic and electrical connection units, designated by 10, 30, 50 and 60 in FIG. 3, being connected to the individual supply strands of the main strand 20. The ends of the sheath 22 are connected to a metallic connection body 34 via a hose connector designated by 32 in FIG. 1, which is fastened to the facing base body 36 (FIG. 1) of the coupling parts 26, 28. The connection body 34 is formed by a sleeve, which tapers slightly conically from the relevant base body 36 towards the sheath 22, such that the connection body 34 forms a line or hose bundle for the supply strands running in the sheath 22. For supply purposes, the first coupling part 26 can be detachably connected to the operating system for the supply located in the joint 12 via a corresponding, coupling part, not shown, and the second coupling part 28 can be connected in a similar manner to a corresponding coupling part, not shown, for output to the effector 10.

A standardized connection device each is provided for the removable attachment of the main strand 20 at the joint 12 and at the arm part 8, which connection device has an identically formed bracket 40 as retainer of the coupling parts 26, 28 in every case, wherein a leg of the second coupling part 28 is detachably connected to the side surface of the arm part 8 using screws 42, as shown in FIG. 2. In a corresponding manner, one leg of the bracket 40 of the first coupling part 26 is detachably connected to the side surface of the joint part 14. The relevant other leg of the bracket 40 has an opening penetrated by a base body 36 of the coupling parts 26 and 28 as retainer, in which the relevant coupling part 26, 28 is secured when they are coupled to the corresponding coupling part (not shown). If, in this arrangement, the main strand is replaced in order to eliminate a defect or provide different supply lines for a different operation, the decoupled coupling parts 26 and 28 can be removed from the receiving hole in the bracket 40, without the brackets 40 having to be unscrewed. The supply device according to the invention does not have to be limited to the application in handling systems, such as robots, but can be used anywhere where generally such utilities are useful as exchangeable replacement units, for example in machine tools, in medical or food technology, automotive, aerospace and rail vehicles etc.

1. A handling system, having a handling arm (4), which preferably consists of several arm parts (6, 8) moved by means of at least one drive, which arm parts are interconnected via joints (12, 18), and having a supply device (20), which comprises individual supply strands, which serve the supply of electrical and/or fluidic energy to loads, such as the relevant drive, and which are at least partially part of the handling arm (4) and its arm parts (6, 8), characterized in that the individual supply strands are combined to form a common main strand (20), which has a port-coupling part (26, 28) at each end, which surrounds the supply strands with a protective sheath (22) and which, designed as a exchangeable unit, is mounted via the two coupling parts (26, 28) on retainers (40) located on the handling arm (4) in a detachable manner and accessible from the outside.

2. The handling system according to claim 1, characterized in that the first free end or first coupling part (26) of the main strand (20) is arranged on a joint (12) assigned to the first arm part (6) and its other free end or second coupling part (28) is arranged on the last arm part (8) of the handling arm (4) and that the first coupling part (26) is used to supply the energy and the second coupling part (28) is used to output the supplied energy.

3. The handling system according to claim 1, characterized in that the first arm part (6) is pivotally mounted on a base (2) and that the last arm part (8) of the handling arm (4) has a handling or processing unit (10) to be supplied with energy.

4. The handling system according to claim 1, characterized in that the sheath (22) of the main strand (20) is flexible just like the individual supply strands, and follows each intended movement of the arm parts (6, 8) of the handling arm (4), such that, in particular in the extended state of the handling arm (4) and parallel to it, it ensures the supply of energy and infeed.

5. The handling system according to claim 1, characterized in that except for the two coupling parts (26, 28) and their retainers (40), the main strand (20) is arranged freely movable along the outside of the arm parts (6, 8) extending along a plane of movement thereof.

6. The handling system according to claim 1, characterized in that the main strand (20) undergoes a maximum deflection at the relevant joint (12, 18), during which the strand parts of the main strand (20) including the relevant coupling part (26, 28), adjacent to the [point of] deflection can be brought in contact with each other without any kinks.

7. The handling system according to claim 1, characterized in that the relevant retainer has a standardized connection device for a coupling part (26, 28) of the main strand (20), which connection device can be connected to an dedicated retainers (40) on one of the arm parts (6, 8) in a detachable manner, and that all exchangeable main strands (20), even those having a different configuration, can be attached to the relevant arm part (6, 8) using the standardized connection device.

8. A supply device having individual flexibly formed supply strands, which supply electrical and/or fluidic energy, in particular provided for a movable arm (4) of a handling system according to claim 1, characterized in that the individual supply strands are combined to a common main strand (20), the ends each having a port-coupling part (26, 28), with a flexible sheath (22), which surrounds the supply strands with a protective covering and which, designed as an exchangeable unit, can be mounted by means of retainers (40) on the coupling parts (26, 28) on third components, such as arm parts (6, 8) of the movable arm (4), in a detachable manner.

9. The supply device according to claim 8, characterized in that the relevant supply strand is formed from an electrical supply cable or a cable transmitting information or a pneumatic or hydraulic connecting line, which each end in connector parts on both sides, which are routed in the assignable coupling part (26, 28).

10. The supply device according to claim 8, characterized in that at each end of the main strand (20) a bolting feature (32) is provided for attaching a hose bundle (34) as a connecting transition to the relevant coupling part (26, 28).
